(19) United States
(12) Patent Application Publication
(10) Pub. No.: US 2015/0093807 A1
(43) Pub. Date: Apr. 2, 2015

(54) METHOD FOR CONTROLLING DEGRADATION OF BIODEGRADABLE POLYESTER AND DEGRADATION-CONTROLLED BIODEGRADABLE POLYESTER

(71) Applicant: INDUSTRY-ACADEMIC COOPERATION FOUNDATION GYEONGSANG NATIONAL UNIVERSITY, Jinju (KR)

(72) Inventors: Sung-Chul YOON, Jinju (KR); Mun-Hwan Choi, Jinju (KR)

(21) Appl. No.: 14/477,809

(22) Filed: Sep. 4, 2014

Related U.S. Application Data
(63) Continuation-in-part of application No. PCT/KR2013/001217, filed on Feb. 15, 2013.

(30) Foreign Application Priority Data
Mar. 9, 2012 (KR) 10-2012-0024628

(51) Int. Cl. C08G 63/91

(52) U.S. Cl. CPC C08G 63/912
USPC 435/262.5; 525/450

(57) ABSTRACT

The present disclosure relates to a method for controlling degradation of biodegradable polyester. To be specific, biodegradation caused by a depolymerase is suppressed by capping a carboxyl terminal in biodegradable polyhydroxyalkanoate (PHA) having the carboxyl group at one terminal or its copolymer, and, thus, it is possible to easily suppress or control degradation depending on a capping ratio of the carboxyl group.

### TECHNICAL FIELD

The present disclosure relates to a method for controlling biodegradation of biodegradable polyester such as polyhydroxyalkanoate, and degradation-controlled biodegradable polyester.

### BACKGROUND

Microorganisms produce proteins, nucleic acids, polysaccharides, and the like, and ingest organic matters as materials for storing energy so as to be stored in cells or discharged from the body. A biodegradable polymer mainly containing carbohydrates produced at that time is easily degraded by microorganisms in soil into a carbonic acid gas and water in the presence of air or methane and water under the air-blocked condition.

Up until now, it is known that numerous microorganisms accumulate polyester in cells as an energy storage material. A homopolymer of hydroxyalkanoate or polyhydroxyalkanoate (hereinafter, abbreviated to “PHA”) as a copolymer thereof is a thermoplastic polymer, can be degraded by microorganisms during composting or in the natural environment, and has received attention as eco-friendly plastic. Such biodegradable plastic has been developed for a wide range of application to agricultural materials used in the environment, food containers, packing materials, hygienic goods, and garbage bags which are difficult to collect and reuse after use.

Such biodegradable plastic is degraded by microorganisms, and, thus, it is difficult to control degradation.

Korean Patent Laid-open Publication No. 2011-0002951 describes a method for preparing hydroxyalkanoate alkylester by allowing PHA to carry out autolysis in microorganisms so as to produce hydroxyalkanoate, adding alcohol thereto to make a reaction therewith. This technology is about production of biodiesel through chemical degradation instead of biodegradation using a depolymerase.

Japanese Patent Laid-open Publication No. 2009-207424 provides a method for decomposing a polyhydroxyalkanoic acid at 55 to 80° C. in the presence of bacteria of genus Thermobifida, an enzyme composed of a specific amino acid sequence isolated from the bacteria, its variant or a transformant. The same document describes a microorganism for easy PHA decomposition but does not describe a method for controlling the decomposition.

### SUMMARY

The present disclosure has been made in an effort to provide a method for simply controlling, for example, blocking or suppressing, degradation of biodegradable polyester.

Further, the present disclosure has been made in an effort to provide to biodegradation-controlled biodegradable polyester.

Furthermore, the present disclosure has been made in an effort to provide to a degradation suppressing mechanism for suppressing degradation by studying a degradation mechanism of biodegradable polyester.

An exemplary embodiment of the present disclosure provides a method for controlling degradation of biodegradable polyester, including: blocking biodegradation by capping a carboxyl terminal of the biodegradable polyester.

Herein, the biodegradable polyester is not specifically limited as long as it has a carboxyl group at its one terminal, and may contain polyesters including, for example, polylactic acid (PLA), polyglycolic acid (PGA), poly(D,L-lactide-co-glycolide) (PLGA), polycaprolacton (PCL), polyhydroxyalkanoate (PHA), polyesters composed of aliphatic dicarboxylic acid (for example, succinic acid, and the like.), and aliphatic diol (for example, ethylene glycol, butane diol, and the like.), and mixtures thereof.

Another exemplary embodiment of the present disclosure provides a method for controlling degradation of biodegradable polyester, including: suppressing biodegradation caused by a depolymerase by capping the carboxyl terminal in biodegradable polyhydroxyalkanoate (PHA) having a carboxyl group at its one terminal or in its copolymer.

The biodegradable PHA is not specifically limited and includes a homopolymer and a copolymer and also includes medium-chain length PHA (about 6 to 14 carbon atoms) and short-chain length PHA (about 3 to 5 carbon atoms). In a specific example, the biodegradable PHA includes: poly[3-hydroxybutylate] (P(3HB)); poly[(4-hydroxybutylate] (P(4HB)); poly[3-hydroxyvalerate] (PHV); poly[3-hydroxybutylate]-co-poly[3-hydroxyvalerate] (PHBV); poly[3-hydroxyhexanoate] (PHC); poly[3-hydroxyheptanoate] (PHH); poly[3-hydroxyoctanoate] (PHO); poly[3-hydroxynonanoate] (PHN); poly[3-hydroxydecanoate] (PHD); poly[3-hydroxydodecanoate] (PHDD); poly[3-hydroxytetradecanoate] (PHTD); and mixtures thereof.

In the method for controlling degradation of biodegradable polyester according to the present disclosure, capping the carboxyl terminal may be carried out by, for example, esterification, amidation, or PEGylation.

These capping methods can be modified appropriately for the present disclosure and carried out according to the well-known methods. For example, the esterification may be carried out through an esterification reaction, a transesterification reaction, a polyesterification reaction, or a transpolyesterification reaction of a capping compound selected from monovalent aliphatic alcohol, polyalcohol, thiol, aromatic alcohol, and mixtures thereof.

In the present disclosure, biodegradation is carried out by a depolymerase, and in a preferable example, the depolymerase may be an exo-extracellular depolymerase. More preferably, the depolymerase may have a carboxyl group searching capability and may include a carboxyl group-binding domain.

In the method for controlling degradation according to the present disclosure, degradation can be controlled depending on a capping ratio of the carboxyl terminal. For example, if the carboxyl terminal is entirely capped, degradation is completely blocked, and if the carboxyl terminal is partially capped, degradation is highly suppressed as a capping ratio increases.

Yet another exemplary embodiment of the present disclosure provides degradation-controlled biodegradable PHA in which a carboxyl terminal of biodegradable polyhydroxyalkanoate (PHA) having a hydroxyl group and a carboxyl group at its terminals, respectively, or a carboxyl terminal of its copolymer is capped.

Herein, capping of the carboxyl terminal may be carried out by esterification, amidation, or PEGylation, as described above.

Still another exemplary embodiment of the present disclosure provides a degradation mechanism of biodegradable polyester and a degradation control mechanism of biodegradable polyester.

The degradation mechanism of biodegradable polyester includes: (a) a step in which a depolymerase is bonded to a biodegradable polyester-binding domain; (b) a step in which the depolymerase moves toward a carboxyl terminal; (c) a step in which the depolymerase recognizes and anchors the carboxyl terminal of the biodegradable polyester; and (d) a step in which the depolymerase degrades the biodegradable polyester while moving toward a hydroxyl terminal of the biodegradable polyester in a reverse direction from the direction of the step (b).

Herein, in the degradation control mechanism of biodegradable polyester, during the step (b), movement toward the carboxyl terminal is controlled, or during the step (c), recognition or anchoring of the carboxyl terminal is controlled.

Controlling the movement toward the carboxyl terminal during the step (b) may be carried out using, for example, a mutant depolymerase having lost a carboxyl group searching capability. Herein, as described above, the depolymerase is an exo-extracellular depolymerase and preferably, it has a carboxyl group searching capability and includes a carboxyl group-binding domain.

Further, controlling the recognition or anchoring of the carboxyl terminal during the step (c) may be carried out by, for example, capping the carboxyl terminal. Herein, a method for capping the carboxyl terminal is as described above.

According to the exemplary embodiments of the present disclosure, the method for controlling degradation of biodegradable polyester includes a simple method of capping a carboxyl terminal, and it is easy to control. Therefore, the present disclosure can be applied for various uses to retard or block degradation of biodegradable polyester, such as drug release control.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example of a degradation mechanism of biodegradable polyester;

FIG. 2 is a schematic diagram of naturally occurring PHB nanogranules in which the core is chelated with cations Ca²⁺;

FIG. 3 is a result of 1H NMR analysis from Experimental Example 1;

FIG. 4 is a result of Thermal transition analysis from Experimental Example 1;

FIG. 5 is a result of XRD analysis from Experimental Example 1 (a: naturally occurring PHB particles, b: naturally occurring PHB particles washed with acetone, c: artificially assembled PHB particles, d: PHB-1-octadecanol nanoparticles suspended in water, e: PHB-1-octadecanol dry powder).

FIG. 6 is a graph illustrating time-dependent degradation profiles from Experimental Example 2 in which filled symbols represent degradation profiles of PHB-1-octadecanol of which a carboxyl terminal is capped, and open symbols represent degradation profiles of PHB particles of which a carboxyl terminal is not capped.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Unless defined otherwise, all technical terms used herein have the same meaning as those commonly understood to one of ordinary skill in the art to which this invention pertains. Further, in the present specification, preferable methods or specimens will be described, but those similar or equivalent thereto are included in the scope of the present disclosure. All the publications cited as references in the present specification are incorporated herein by reference in their entirety.

The term “biodegradable polymer” used herein refers to a degradable polymer material in which the degradation results from the action of naturally occurring microorganisms such as bacteria, fungi, and algae. Typically, “biodegradation” is classified into intracellular degradation and extracellular degradation. For example, the intracellular degradation refers to hydrolysis of bacteria, which synthesize PHA, by an intracellular PHA depolymerase in order to use PHA during an intracellular metabolic process. The extracellular degradation is carried out by an extracellular depolymerase which is an enzyme secreted from cells by microorganisms in order to use PHA present in the natural environment as a carbon source. In the present disclosure, preferably, biodegradation may be extracellular biodegradation carried out using an extracellular depolymerase.

The term “polyhydroxyalkanoate” or “PHA” refers to a polymer material having a repetitive unit expressed by the following General Formula 1. Up until now, PHA includes 100 or more kinds of constituent monomers and is classified into a short-chain length PHA (n=0 to 1), a medium-chain length PHA (n=2 to 11), and a long-chain length PHA (n=12 or more) depending on a length of a side chain R of a repetitive unit. The present disclosure includes all of them. Further, in the present disclosure, PHA includes chemical synthetic polymers, microbial synthetic polymers, or naturally occurring polymers.

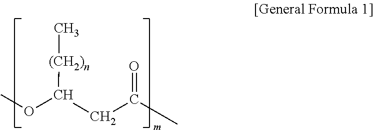

The term “capping” or “chemical modification” is interchangeably used to refer to introduction of a blocking group to a polymer terminal by covalent modification. Preferably, the blocking group helps with capping of a terminal without reducing biological activity of biodegradable polyester.

The term “esterification” refers to a reaction in which an acyl group or alcohol is shifted and bonded again to another molecule or another site in the same molecule and at the same time when an ester bond is broken. In the present disclosure, esterification includes an esterification reaction, a transesterification reaction, a polyesterification reaction, or a transpolyesterification reaction.

The term “about” indicates an amount, level, value, number, frequency, percent, dimension, size, weight, or length changed by 30, 25, 20, 25, 10, 9, 8, 7, 6, 5, 4, 3, 2, or 1% of the reference amount, level, value, number, frequency, percent, dimension, size, weight, or length.

It should be understood that the terms “comprises”, “has”, “includes”, “contains” and/or “comprising”, “having”, “including”, “containing” when used in this specification, specify the presence of steps or elements, or groups thereof, but do not preclude the presence or addition of one or more other steps or elements, or groups thereof unless otherwise deemed necessary.

Hereinafter, the present disclosure will be explained in detail.

Method for Controlling Degradation of Biodegradable Polyester

The present disclosure includes a step of blocking biodegradation by capping a carboxyl terminal of biodegradable polyester.

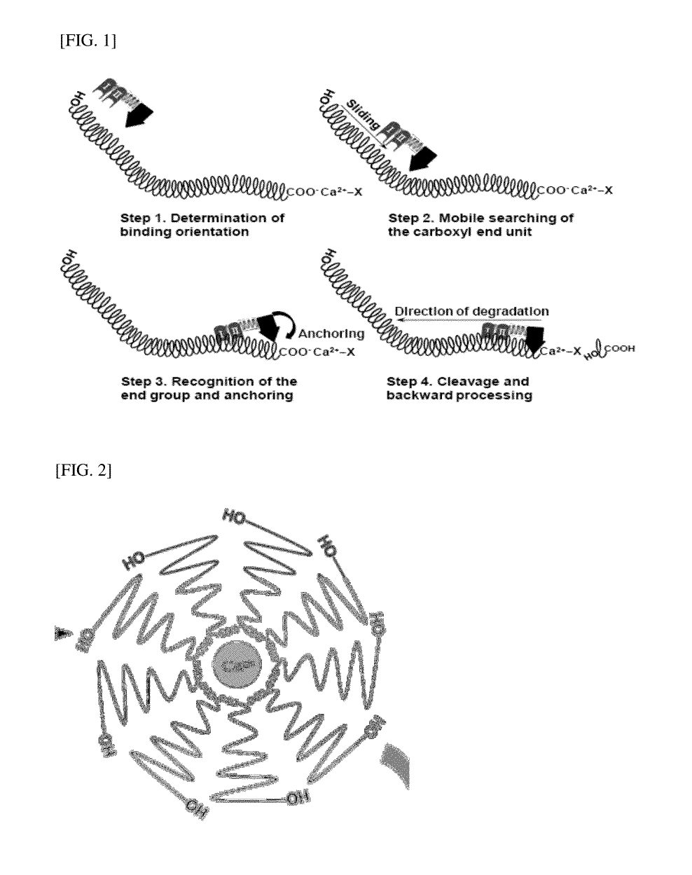

The inventors of the present disclosure studied a degradation mechanism of biodegradable polyester and found that a depolymerase recognizes a carboxyl terminal and anchors at the carboxyl terminal and then proceeds degradation. Referring to FIG. 1, the degradation mechanism is as follows.

<Degradation Mechanism of Biodegradable Polyester>

(a) a step in which a depolymerase is bonded to a biodegradable polyester-binding domain (Step 1);

(b) a step in which the depolymerase moves toward a carboxyl terminal (Step 2);

(c) a step in which the depolymerase recognizes and anchors the carboxyl terminal of the biodegradable polyester (Step 3); and

(d) a step in which the depolymerase degrades the biodegradable polyester while moving toward a hydroxyl terminal of the biodegradable polyester in a reverse direction from the direction of the step (b) (Step 4).

According to the finding of the inventors of the present disclosure, recognition of a free carboxyl group at a terminal by a depolymerase is important in degradation, and degradation proceeds while moving toward a hydroxyl terminal. Therefore, in order to degrade biodegradable polyester, the following two methods can be considered.

Firstly, there is a method of controlling movement toward the carboxyl terminal during the step (b). In order to do so, a mutant depolymerase having lost a carboxyl group searching capability may be used. However, according to this method, it is useful to block degradation itself but difficult to quantitatively control degradation.

Secondly, there is a method of controlling recognition or anchoring of the carboxyl terminal during the step (c). In this regard, the inventors of the present disclosure caps the carboxyl terminal in order for the depolymerase not to recognize the carboxyl terminal. Therefore, if the carboxyl terminal is entirely capped, degradation is completely blocked, and if the carboxyl terminal is partially capped, a degradation blocking ratio varies depending on a capping ratio. It is possible to easily control degradation by regulating a capping ratio.

In the present disclosure, a method of capping the carboxyl terminal is not specifically limited, and may include, for example, esterification, amidation, or PEGylation.

In an example, the esterification may be carried out with a capping compound selected from monovalent aliphatic alcohol, polyalcohol, thiol, aromatic alcohol, and mixtures thereof. The esterification can be carried out without addition of a catalyst, but preferably, may be carried out under activity of a catalyst. Alkanol having 1 to 18 carbon atoms may be generally used as a useful low-molecular alcohol. To be specific, n-butanol, n-hexanol, n-octanol, n-decanol, n-dodecanol, octadecanol, and mixtures thereof may be used.

In the amidation according to an example, a capping compound selected from the group consisting of, for example, ethyl amine, propyl amine, butyl amine, octyl amine, stearyl amine, and mixture thereof may be added at the carboxyl terminal using a method known in the art.

In an example, the carboxyl terminal may be chemically modified and PEGylated by a reaction with appropriately functionalized PEG.

In the present disclosure, biodegradation is carried out using a depolymerase, and preferably, the depolymerase is an exo-extracellular depolymerase.

As the extracellular depolymerase, depolymerases such as PHB, PHV, and PHO (polyhydroxyoctanoate) are known, and each of these depolymerases exhibits substrate specificity. The depolymerase PHB is classified by a structural characteristic, and includes a signal peptide cut off while passing through a plasma membrane, a catalytic domain at a N-terminal residue and a substrate-binding domain at a C-terminal residue, and a linking domain that links these domain. Serine, aspartate, and histidine are strictly conserved at the active center of the catalytic domain. Serine of them constitutes a lipase box pentapeptide, Gly-Xaa-Ser-Xaa-Gly.

In a preferable example, the extracellular depolymerase of the present disclosure may have a carboxyl group recognition capability from a substrate in order to recognize and anchor the carboxyl terminal, and may include a carboxyl group-binding domain. For example, Pseudomonas stutzeri, Ralstonia pickettii, Comamonas testosterone, Pseudomonas lemoignei, Pseudomonas fluorescens, Alcaligenes faecalis, and Streptomyces exfoliates may be included.

Degradation-Controlled Biodegradable PHA

The present disclosure provides a degradation-controlled biodegradable PHA in which a carboxyl terminal of biodegradable polyhydroxyalkanoate (PHA) having a hydroxyl group and a carboxyl group at its terminals, respectively, or a carboxyl terminal of its copolymer is capped. The carboxyl terminal may be capped by, but not specifically limited to, esterification, amidation, or PEGylation, as described above.

Herein, biodegradation is extracellular biodegradation carried out using an exo-extracellular depolymerase having a carboxyl group recognition capability and including a carboxyl group-binding domain.

The degradation-controlled biodegradable PHA according to the present disclosure may be prepared by capping naturally occurring or synthetic PHA obtained by the method known in the art. In an example, the degradation-controlled biodegradable PHA may be prepared by reacting and capping a carboxyl group at the other terminal of the biodegradable PHA with a capping compound.

According to the finding of the inventors of the present disclosure, as illustrated in FIG. 2, the naturally occurring intracellular PHA nanogranules includes the hydroxyl terminal at an outer periphery and the carboxyl terminal at the core side, and has a core shell structure in which the core side is chelated with divalent cations. Herein, preferably, remarkable distortion or modification interfering with folding for crystallization does not occur in the degradation-controlled biodegradable PHA of the present disclosure despite terminal capping.

Hereinafter, the present disclosure will be further explained with reference to Examples. The following Examples are provided for more specific explanation, and the scope of the present disclosure is not limited thereto.

Particularly, in the following Examples, PHB is exemplified as biodegradable polyester and 1-octadecanol is exemplified as a capping compound. It is also obvious for those skilled in the art to use other kinds of biodegradable polyester, capping compounds, and esterification catalysts.

### Example 1

A transesterification reaction of PHB was carried out at 190° C. for 20 to 30 minutes. Herein, low-molecular PHB was obtained by degrading high-molecular PHB. A hydroxyl group at one terminal of the PHB was removed by pyrolysis and converted into an alkenic group, and a carboxyl group at the other terminal was not damaged. A transesterification reaction of low-molecular PHB obtained as such was carried out in the presence of a tin catalyst. Thus, PHB with an esterified terminal was obtained.

To be specific, PHB and 1-octadecanol or 1-dodecanol were put into a 25 mL-round flask at a weight ratio of 1:0.5 with magnetic stirring. The reaction was carried out in an oil bath pre-heated to 190° C. in a vacuum, and about 70 mg of a tin catalyst was added into the flask. The reaction was carried out for 20 to 30 minutes with continuous stifling. After the reaction was completed, the flask was removed and a reaction product was cooled in ice or at room temperature. A modified polymer was dissolved in chloroform, and then purified in quickly stirred methanol (yield of 40 to 50%). In a chemical structure of the thus obtained PHB-1-octadecanol as expressed by the following Chemical Formula 1, two kinds of PHB-1-octadecanol including one with a remaining terminal hydroxyl group and the other one with an alkenic group converted from a hydroxyl group were mixed.

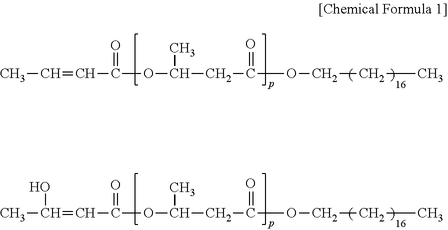

### Experimental Example 1

In order to study the chemical structure of the PHB with a terminal capped from Example 1, ¹H NMR spectroscopic analysis and XRD analysis were conducted.

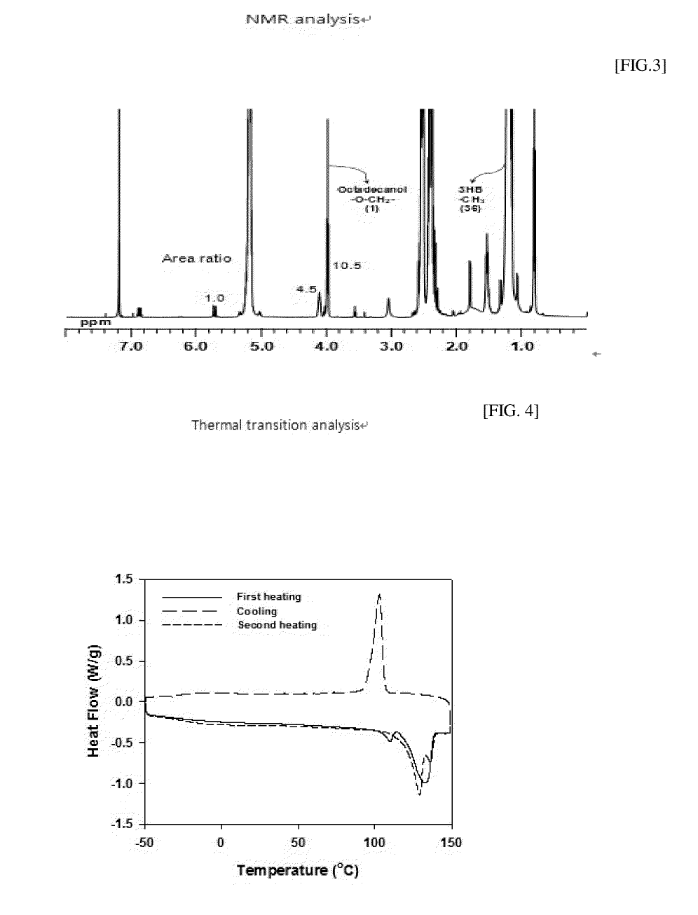

FIG. 3 illustrates a ¹H NMR spectrum of PHB-1-octadecanol. An absorption peak at 3.99 ppm exhibits triplet methylene proton in a terminal alcohol group forming an ester bond at a bond site between PHB and 1-octadecanol. The low absorption peaks at 6.88 ppm and 5.73 ppm (c and d, respectively) involve an olefin terminal group caused by dehydration of the terminal hydroxyl group.

The NMR peak analysis exhibits that in the purified PHB-1-octadecanol sample, about 20% of hydroxyl groups were replaced by alkenic groups and about 80% of free hydroxyl groups were maintained. Further, it exhibits that 98% or more of carboxyl terminals were esterified with 1-octadecanol. According to the thermal transient analysis, Tₘ of the PHB-1-octadecanol was about 130° C. (refer to FIG. 4). A number average molecular weight (Mn) calculated from the ¹H NMR spectroscopic analysis result was about 3000.

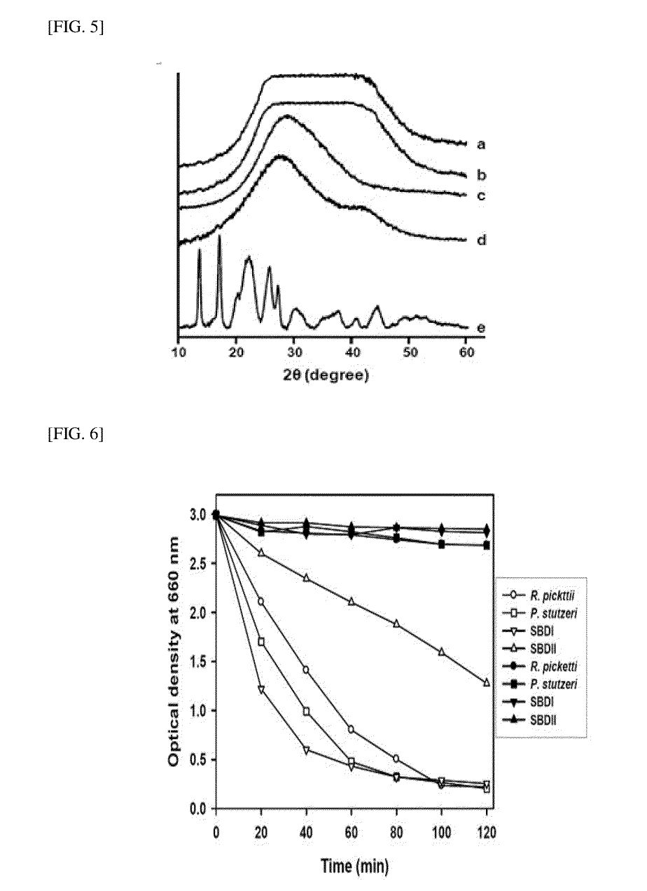

Further, referring to FIG. 5, it was confirmed that the PHB-1-octadecanol nanoparticles (about 20 nm) suspended in water was amorphous according to the XRD analysis result, and PHB-1-octadecanol dry powder exhibited the same pattern as a crystal peak of a PHB homopolymer. Therefore, it can be seen that terminal capping does not cause remarkable distortion or modification interfering with folding for crystallization.

### Experimental Example 2

The PHB-1-octadecanol with a terminal capped was degraded at an enzyme concentration of 2 μg/mL in a tris buffer in which a PHB-1-octadecanol nanoparticles substrate having an initial O.D. of 3.0 (660 nm) was added using P. stutzeri BM190 and R. pickettii T1 as PHB depolymerases. For comparison, artificial PHB particles and naturally occurring PHB particles were also degraded at the same enzyme concentration. A time-dependent degradation profile of the PHB-1-octadecanol with a terminal capped was obtained and compared with a degradation profile of artificial PHB nanoparticles of which a terminal was not capped.

As illustrated in FIG. 6, when the terminal carboxyl group was capped, degradation was completely blocked by each enzyme. This means that a free carboxyl group at a terminal was the most important factor in degradation, and a process of cutting a polymer toward a hydroxyl terminal was the next important factor. PHB-1-dodecanol was not degraded either (data are not illustrated).

On the other hand, the control of which a terminal was not capped was rapidly degraded. It is deemed that a high degradation rate within less than 1 hour is caused by recognition of the free carboxyl terminal by the enzyme.

While the present disclosure has been exhibited and described with reference to preferable Examples thereof, it will be understood by those skilled in the art that various changes in form and details may be made therein without departing from the spirit and scope of the present disclosure as defined by the appended claims. Therefore, the disclosed Examples should be considered in view of explanation, but no limitation. The technical scope of the present disclosure is taught in the claims, but not the detailed description, and all the differences in the equivalent scope thereof should be construed as falling within the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for controlling degradation of biodegradable polyester, comprising:
blocking biodegradation by capping a carboxyl terminal of the biodegradable polyester.

2. The method for controlling degradation of biodegradable polyester of claim 1, wherein the biodegradable polyester is selected from the group consisting of polyesters including polylactic acid (PLA), polyglycolic acid (PGA), poly(D,L-lactide-co-glycolide) (PLGA), polycaprolacton (PCL), polyhydroxyalkanoate (PHA), polyesters composed of aliphatic dicarboxylic acid and aliphatic diol, and mixtures thereof

3. A method for controlling degradation of biodegradable polyester, comprising:
suppressing biodegradation caused by a depolymerase by capping a carboxyl terminal in biodegradable polyhydroxyalkanoate (PHA) having the carboxyl group at its one terminal or in its copolymer.

4. The method for controlling degradation of biodegradable polyester of claim 3, wherein the polyhydroxyalkanoate (PHA) is selected from the group consisting of poly[3-hydroxybutylate] (PHB) or poly(β-hydroxy acid); poly[(4-hydroxybutylate] (PHB); poly[3-hydroxyvalerate] (PHV); poly[3-hydroxybutylate]-co-poly[3-hydroxyvalerate] (PHBV); poly[3-hydroxyhexanoate] (PHC); poly[3-hydroxyheptanoate] (PHH); poly[3-hydroxyoctanoate] (PHO); poly[3-hydroxynonanoate] (PHN); poly[3-hydroxydecanoate] (PHD); poly[3-hydroxydodecanoate] (PHDD); poly[3-hydroxytetradecanoate] (PHTD); and mixtures thereof.

5. The method for controlling degradation of biodegradable polyester of claim 1, wherein the carboxyl terminal is capped by esterification, amidation, or PEGylation.

6. The method for controlling degradation of biodegradable polyester of claim 5, wherein the esterification is carried out with a capping compound selected from monovalent aliphatic alcohol, polyalcohol, thiol, aromatic alcohol and mixtures thereof.

7. The method for controlling degradation of biodegradable polyester of claim 1, wherein the depolymerase is an exo-extracellular depolymerase.

8. The method for controlling degradation of biodegradable polyester of claim 7, wherein the depolymerase has a carboxyl group searching capability and includes a carboxyl group-binding domain.

9. The method for controlling degradation of biodegradable polyester of claim 1, wherein the carboxyl terminal is entirely or partially capped, and degradation is controlled depending on a capping ratio of the carboxyl terminal.

10. Degradation-controlled biodegradable PHA in which a carboxyl terminal of biodegradable polyhydroxyalkanoate (PHA) having a hydroxyl group and a carboxyl group at its terminals, respectively, or a carboxyl terminal of its copolymer is capped.

11. The degradation-controlled biodegradable PHA of claim 10, wherein the carboxyl terminal is capped by esterification, amidation, or PEGylation.

12. The degradation-controlled biodegradable PHA of claim 10, wherein the biodegradable PHA is biodegraded by an exo-extracellular depolymerase having a carboxyl group searching capability and including a carboxyl group-binding domain.

13. A degradation mechanism of biodegradable polyester comprising:
(a) a step in which a depolymerase is bonded to a biodegradable polyester-binding domain;
(b) a step in which the depolymerase moves toward a carboxyl terminal;
(c) a step in which the depolymerase recognizes and anchors the carboxyl terminal of the biodegradable polyester; and
(d) a step in which the depolymerase degrades the biodegradable polyester while moving toward a hydroxyl terminal of the biodegradable polyester in a reverse direction from the direction of the step (b),
wherein during the step (b), movement toward the carboxyl terminal is controlled, or
during the step (c), recognition or anchoring of the carboxyl terminal is controlled.

14. The degradation control mechanism of biodegradable polyester of claim 13, wherein the movement toward the carboxyl terminal is controlled using a mutant depolymerase having lost a carboxyl group searching capability.

15. The degradation control mechanism of biodegradable polyester of claim 13, wherein the recognition of the carboxyl terminal is controlled by capping the carboxyl terminal.

16. The method for controlling degradation of biodegradable polyester of claim 3, wherein the carboxyl terminal is capped by esterification, amidation, or PEGylation.

17. The method for controlling degradation of biodegradable polyester of claim 3, wherein the depolymerase is an exo-extracellular depolymerase.

18. The method for controlling degradation of biodegradable polyester of claim 3, wherein the carboxyl terminal is entirely or partially capped, and degradation is controlled depending on a capping ratio of the carboxyl terminal.
